(19) United States
(12) Patent Application Publication
(10) Pub. No.: US 2020/0049173 A1
(43) Pub. Date: Feb. 13, 2020

(54) Valve System For Flushing Contaminated Hydraulic Fluid

(71) Applicant: CNH Industrial America LLC, New Holland, PA (US)

(72) Inventors: Michael W. Freisleben, Homer Glen, IL (US); Jerry L. Brinkley, Woodridge, IL (US); Joshua M. Guarino, Plainfield, IL (US)

(21) Appl. No.: 16/100,882

(22) Filed: Aug. 10, 2018

(51) Int. Cl. F15B 21/00; F15B 21/04; E02F 9/22

(52) U.S. Cl. CPC F15B 21/005; F15B 21/041; F15B 2211/615; F15B 2211/41554; F15B 2211/46; E02F 9/2267

(57) ABSTRACT

The present inventors have recognized that contaminants in hydraulic fluid in a hydraulic system of an off-highway implement can be efficiently filtered by a filtration system of the source of hydraulic power by conducting an operation which controls existing valves of the system to block the fluid from going through such valves or precisely operated cylinders controlled by such valves while a dedicated return valve returns the fluid to the source of hydraulic power through a connector. Such an operation can be advantageously executed immediately following connection of the source of hydraulic power to the manifold of the implement.

### FIELD OF THE INVENTION

The present invention relates generally to off-highway implements having hydraulic systems, and more particularly, to implements having electronically controlled valves for controlling hydraulic fluid with respect to a hydraulic actuator in which the valves are controlled in an operation to enable filtering of the fluid by either blocking the fluid with respect to the valves and cylinders while a dedicated return valve is controlled to return the fluid to a connector via a return line.

### BACKGROUND OF THE INVENTION

There are a wide variety of off-highway implements which utilize hydraulic power. One example is a tillage implement for preparing soil for planting in which hydraulic power is used to raise and lower tillage shanks. Such implements often receive hydraulic power through hoses with “quick connect couplings” which may be arranged at a central manifold. To conduct off-highway operations, the manifold can be connected to an external hydraulic power source for operating the implement, such as a tractor pulling the implement. However, over time, contaminants in the hydraulic fluid which may enter through the “quick connect couplings” can cause damage to various seals, valves, cylinders and other components. This can potentially lead to pressure intensification, leaks and/or ultimately loss of hydraulic power. A need therefore exists to efficiently enable filtering of such contaminants to minimize one or more of the aforementioned drawbacks.

### SUMMARY OF THE INVENTION

The present inventors have recognized that contaminants in hydraulic fluid in a hydraulic system of an off-highway implement can be efficiently filtered by a filtration system of the source of hydraulic power by conducting an operation which controls existing valves of the system to block the fluid from going through such valves or precisely operated cylinders controlled by such valves while a dedicated return valve returns the fluid to the source of hydraulic power through a connector. Such an operation can be advantageously executed immediately following connection of the source of hydraulic power to the manifold of the implement.

One aspect can provide a bypass circuit in which an addition of hydraulic valves is used to flush contaminated oil from fluid lines connecting a tractor to an implement back to the tractor filtration system prior to being directed to the implement hydraulic circuit along with control software to operate such hydraulic valves. This essentially provides a bypass circuit. Accordingly, this system can flush contaminated oil from high pressure hydraulic fluid lines that connect the tractor to the implement. This is accomplished by bypassing the fluid directly back to the tractor filtration system where it is cleaned. The bypass is created by a hydraulic valve which diverts the oil from the implement hydraulic circuit and sends it to the tractor filtrations system. The software control system engages the tractor operator to perform certain functions to facilitate the flushing of the critical circuits.

Specifically then, one aspect of the present invention can provide an off-highway implement, including: a frame supported by wheels; a set of ground engaging tools supported by the frame, the set of ground engaging tools including a hydraulic cylinder arranged with respect to the frame for raising and lowering the set of ground engaging tools, the hydraulic cylinder including a base, a base port, a rod and a rod port, in which the rod is configured to extend from the base when hydraulic fluid is supplied to the base port and returned from the rod port, and in which the rod is configured to retract toward the base when hydraulic fluid is supplied to the rod port and returned from the base port; a connector configured to supply hydraulic fluid in a supply line and return hydraulic fluid in a return line when connected to a hydraulic power source; multiple electronically controlled valves, the valves including a first valve configured to supply hydraulic fluid from the supply line to the hydraulic cylinder when activated, a second valve configured to return hydraulic fluid from the hydraulic cylinder to the return line when activated, and a third valve configured to bypass the first and second valves by redirecting hydraulic fluid from the supply line to the return line when deactivated; and a controller in communication with the plurality of valves, the controller executing a program stored in a non-transient medium to: execute an operation to enable filtering of the hydraulic fluid supplied through the connector by simultaneously deactivating the first and second valves to block hydraulic fluid with respect to the hydraulic cylinder while deactivating the third valve to redirect hydraulic fluid from the supply line to the return line.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is perspective view of an exemplar off-highway system including an implement being pulled by a tractor which can include a hydraulic system for flushing contaminated hydraulic fluid in accordance with an aspect of the invention;

FIG. 2 is a top view of the implement of FIG. 1, illustrating various hydraulic cylinders for raising and lowering ground engaging tools of the implement;

FIG. 3 is a side view of the implement of FIG. 2, illustrating the various hydraulic cylinders controlling depths of the ground engaging tools;

FIG. 4 is a diagram illustrating control of the hydraulic system of the off-highway system of FIG. 1;

FIG. 5 is a schematic diagram illustrating control of valves of the hydraulic system of FIG. 1 to enable filtering of hydraulic fluid in a first operation;

FIG. 6 is a schematic diagram illustrating control of valves of the hydraulic system of FIG. 1 to enable filtering of hydraulic fluid in a second operation; and

FIG. 7 is a schematic diagram illustrating control of valves of the hydraulic system of FIG. 1 to enable filtering of hydraulic fluid in a third operation.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### DETAILED DESCRIPTION

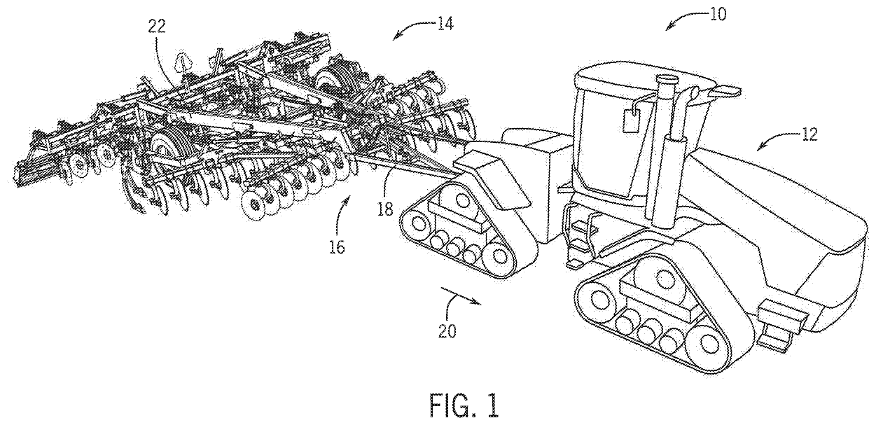

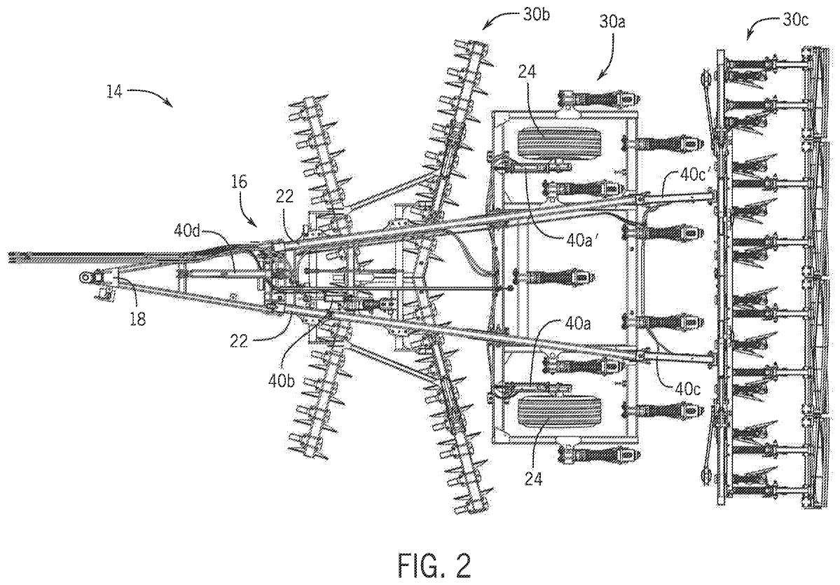

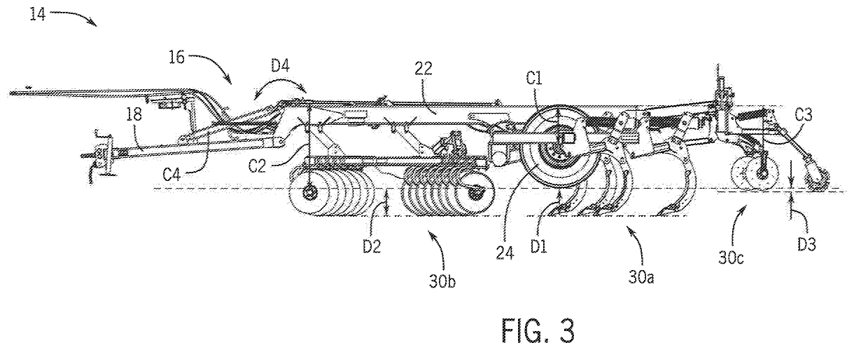

Referring now to the drawings, and more particularly to FIG. 1, there is shown by way of example an off-highway system 10 which generally includes a tractor 12 and an off-highway implement 14 for tilling and finishing soil prior to seeding. With additional reference to FIGS. 2 and 3 showing top and sides views, respectively, the implement 14 can be configured as a multi-section (combination tool) field disk ripper, such as the Ecolo-Tiger 875 disk ripper, as available from CNH Industrial. The implement 14 can include a carriage frame 16 which can be directly towed by a traction unit, such as the tractor 12. The frame 16 can include a pull hitch 18 generally extending in a travel direction 20, and forward and aft directed carrier frame members 22 which are coupled with and extend from pull hitch 18. Reinforcing gusset plates may be used to strengthen the connection between pull hitch 18 and carrier frame members 22.

The frame 16 can be supported by multiple wheels 24. The wheels 24 can be pivoted between a field operation position and a transport position by hydraulic cylinders associated with the wheels. The frame 16, in turn, can support multiple ground engaging tools 30 useful for field operations, including first, second and third sets of ground engaging tools 30a, 30b and 30c, respectively. In one aspect, the first set of ground engaging tools 30a could comprise tillage shanks for ripping compacted soil; the second set of ground engaging tools 30b could comprise disc blades for cutting off-highway residue, such as corn stalks, arranged forward of the tillage shanks; and the third set of ground engaging tools 30c could comprise leveling discs for distributing soil, and/or baskets (or “crumblers”) for breaking large soil clods, arranged rearward of the tillage shanks.

Each set of ground engaging tools includes one or more hydraulic cylinders 40 arranged with respect to the frame 16. The hydraulic cylinders 40 are configured to raise and lower each respective set of ground engaging tool 30 with respect to the frame 16. Accordingly, each set of ground engaging tools 30 can be configured to engage the ground at a ground engaging depth (“D”), when lowered by respective hydraulic cylinders 40, to be in contact with the ground. For example, the first set of ground engaging tools 30a can include cylinders 40a and 40a′ (identified as “C1 LH” and “C1 RH” on left and right sides, respectively, and as “C1” collectively) for raising and lowering the tillage shanks for engaging the ground at a tillage ground engaging depth “D1;” the second set of ground engaging tools 30b can include a cylinder 40b (identified as “C2”) for raising and lowering the disc blades for engaging the ground at a disc blade ground engaging depth “D2;” and the third set of ground engaging tools 30c can include cylinders 40c and 40c′ (identified as “C3 LH” and “C3 RH” on left and right sides, respectively, and as “C3” collectively, mechanically linked through a rockshaft, but hydraulically plumbed in parallel) for raising and lowering the leveling discs and/or baskets for engaging the ground at a leveling ground engaging depth “D3.” In addition, a hydraulic cylinder 40d (identified as “C4”) can be arranged with respect to the frame 16 for changing an angle of the frame 16 (identified as “D4”) with respect to the ground, preferably for leveling the frame 16 with respect to the hitch 18 and the tractor 12.

In operation, retracting C1 lowers the frame 16 (and the first set 30a), whereas extending C1 raises the frame 16; extending C2 raises the disc blades (the second set 30b), whereas retracting C2 lowers the disc blades; extending C3 raises the leveling discs and/or baskets (the third set 30c), whereas retracting C3 lowers the leveling discs and/or baskets; and extending C4 pitches the implement 14 forward (angle of the frame 16), whereas retracting C4 pitches the implement 14 rearward.

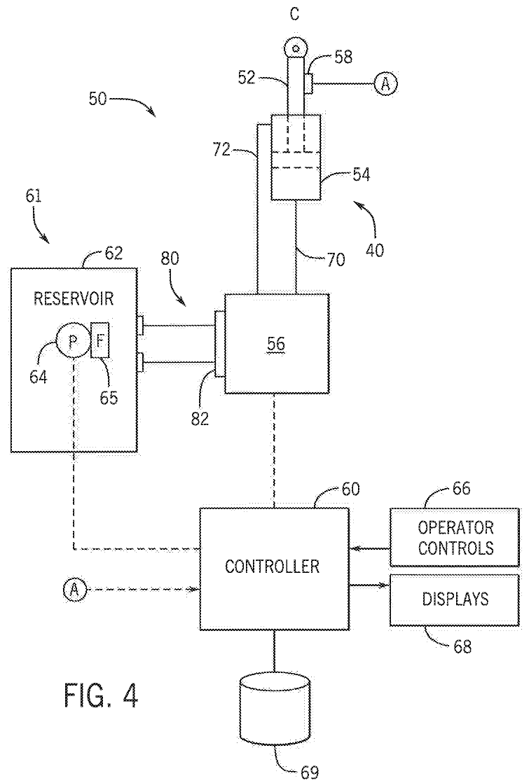

With additional reference to FIG. 4, a schematic diagram for a system 50 for control of the hydraulic system of the off-highway system 10 is provided in accordance with aspect of the invention. Various portions of the system 50 can be on the implement 14 whereas other portions of the system 50 can be on the tractor 12. The system 50, under the control of the controller 60, can control the cylinders 40 (“C”) of the implement 14 to achieve various functions, such as setting each set of ground engaging tools 30 to a given depth, adjusting wheels 24 between field operation and transport positions, and the like. The controller can be located on the implement 14 or the tractor 12 through a CAN bus. Each cylinder 40 includes a movable “piston” or rod 52 that is extendable and retractable from a “cap” or base 54 of the cylinder 40, as fluidly controlled by an electronically controlled valve system 56 (controlled by the controller 60). Each cylinder 40 can be a double acting, single ended hydraulic cylinder with an integrated linear position sensor 58. The controller 60 can selectively energize one or more electronically controlled valves, via solenoids, of the valve system 56 operably connected to the cylinder 40. Valves of the valve system 56 can exchange hydraulic fluid with respect to cylinders 40 for precise control of cylinder lengths. The valve system 56 is fluidly connected to a hydraulic power source 61, which can include a fluid reservoir 62, a pump 64 and a filtration system 65. The hydraulic power source 61 is typically located on the tractor 12, with hoses 80 connected to quick-connect connectors of a manifold 82 located on the implement 14. The pump 64 can be configured to supply hydraulic fluid from the fluid reservoir 62 to the implement 14. The pump 64 could supply hydraulic fluid at a pressure, for example, 3000 psi (pounds per square inch). The filtration system 65 can be configured to filter contaminants from the hydraulic fluid in the circuit. Under control of the valve system 56 and the controller 60, to extend the rod 52 of any particular cylinder 40, hydraulic fluid can be supplied to the cylinder 40 through a base port 70, while hydraulic fluid is also withdrawn from the cylinder 40 through a rod port 72. Also, to retract the rod 52 of any particular cylinder 40, hydraulic fluid can be supplied to the cylinder 40 through the rod port 72, while hydraulic fluid is also withdrawn from the cylinder 40 through the base port 70, as controlled by the valve system 56 and the controller 60. Accordingly, the controller 60 can selectively energize solenoids of the valve system 56 to vary the cylinder length of any of the cylinders 40 as desired. Operator controls 66, which could be within an operator cab of the tractor 12, can receive inputs from an operator for configuring various heights, such as ground engaging depths D1, D2, D3 and/or D4 (angle), for calculating the various cylinder lengths to achieve such heights, and/or for configuring filtering operations of hydraulic fluid as described herein. Various displays 68, which could also be within the operator cab, can provide feedback to the operator.

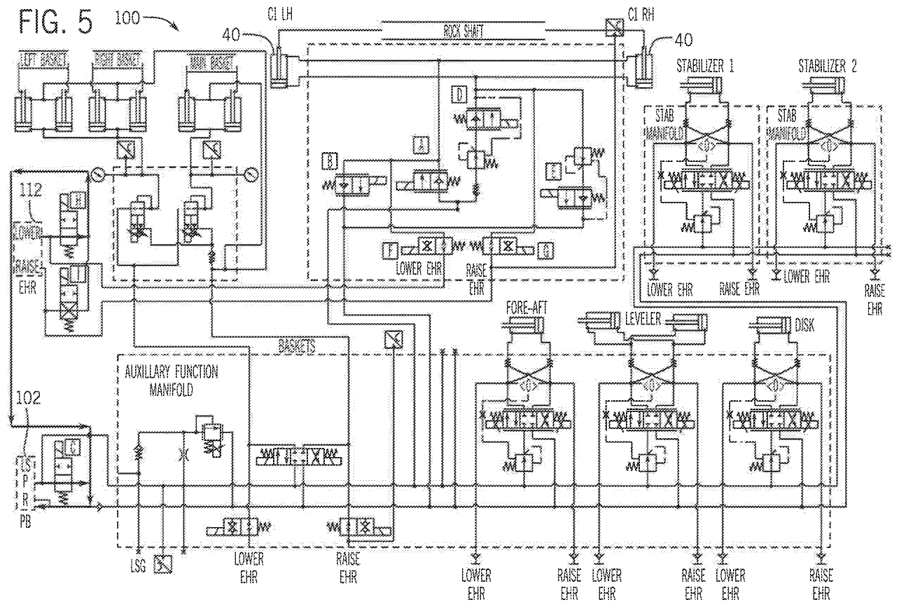

Referring now to FIG. 5, where like numerals refer to like parts throughout, a schematic diagram illustrating control of the valve system 56 in the hydraulic system to enable filtering of hydraulic fluid in a first operation 100 is provided in accordance with an aspect of the invention. A connector 102 is configured to supply hydraulic fluid in a supply line (identified as “P”) and return hydraulic fluid in a return line (identified as “R”). The connector 102 can be part of the manifold 82 and may typically include a “quick-connect” style connectors for connecting hoses 80 from the hydraulic power source 61. The valve system 56 can include a valve “A” configured to supply hydraulic fluid from the supply line P to a port of one or more of the aforementioned hydraulic cylinders 40 when activated, such as the rod ports of C1 RH and C1 LH by way of example; and a valve “B” configured to return hydraulic fluid from the port of the one or more hydraulic cylinders 40 to the return line R when activated, such as the same rod ports of C1 RH and C1 LH. In addition, the valve system 56 can include a valve “C” configured to bypass all valves and cylinders down stream of itself by redirecting hydraulic fluid from the supply line P to the return line R when deactivated. The valves A, B, D and E can be single direction, proportional control valves configured to meter hydraulic fluid for fine adjustment of the cylinder 40. The controller 60 can execute a program stored in non-transient medium 69 to execute the first operation 100 to enable filtering of the hydraulic fluid supplied through the connector 102 by simultaneously deactivating all valves such that valve C redirects the fluid from the supply line P back to the return line R.

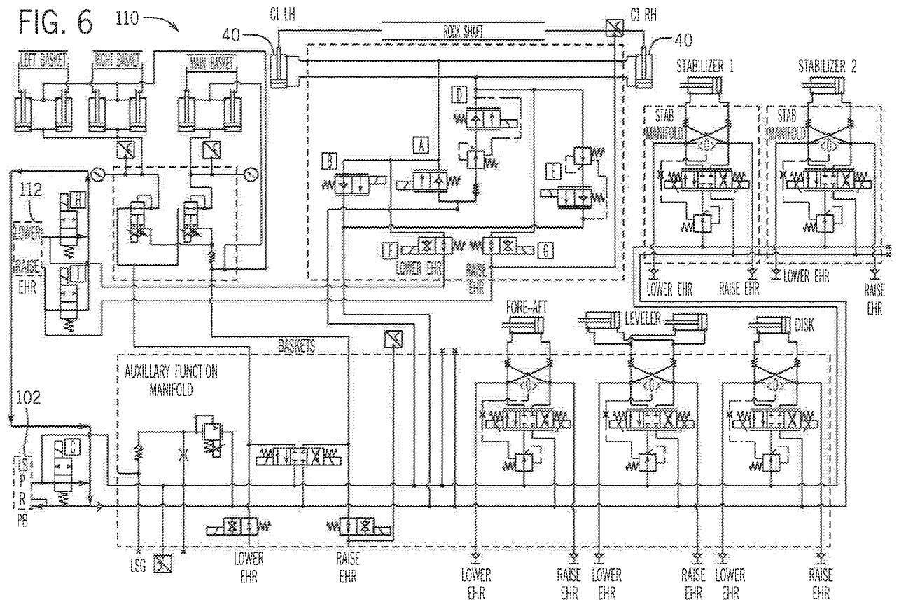

While valves A and B are present to supply and return fluid with respect to the rod port of the cylinder 40, respectively, valves D and E can be present to supply and return fluid with respect to the base port of the same cylinder 40, respectively. Valves D and E can also be single direction, proportional control valves configured to meter hydraulic fluid for fine adjustment of the cylinder 40. In addition, the manifold 82 can include a second connector 112 that may also include “quick-connect” style connectors for connecting additional hoses 80 from the hydraulic power source 61. The valve system 56 can include a valve “F” configured to supply and return hydraulic fluid with respect to the rod port of the cylinder 40 and a first transport line of the second connector 112 (“Lower EHR,” or Lower Electrohydraulic Remote) when deactivated, such as the rod ports of C1 RH and C1 LH; and a valve “G” configured to supply and return hydraulic fluid with respect to the base port of the one or more hydraulic cylinders 40 and a second transport line of the second connector 112 (“Raise EHR,” or Raise Electrohydraulic Remote) when deactivated. The valves F and G can be bi-directional, on-off valves without proportional control for course adjustment of a hydraulic cylinder or to isolate valves A, B, D, & E from Lower and Raise EHR. The valve system 56 can also include a valve “H” configured to bypass the valve F by redirecting hydraulic fluid from the first transport line (Lower EHR) to the return line R when deactivated (FIG. 5); and a valve “I” configured to bypass the valve G by redirecting hydraulic fluid from the second transport line (Raise EHR) to the return line R when deactivated (FIG. 6). The valves H and I can be single direction, on-off valves.

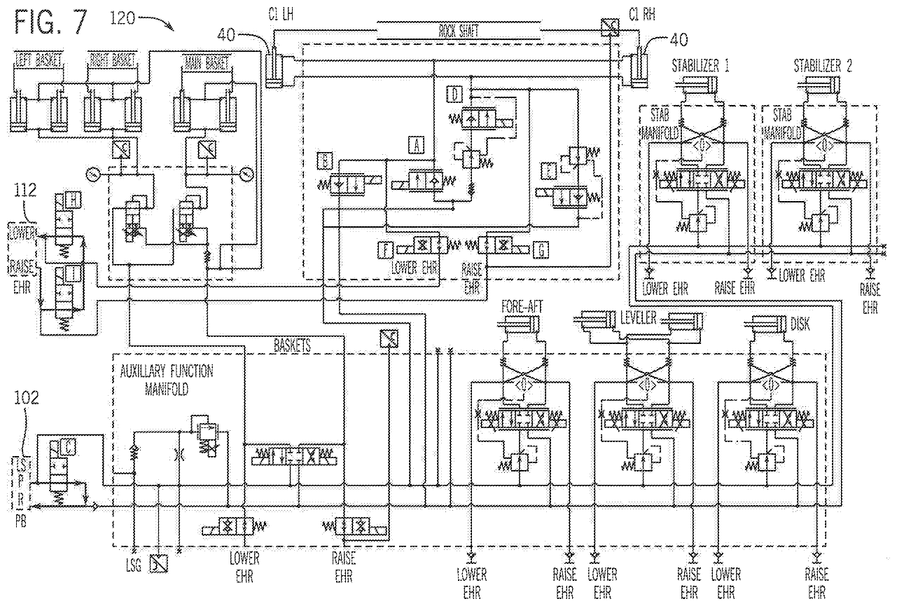

Accordingly, the controller 60 can further execute to enable filtering of the hydraulic fluid supplied through the connector 112 for coarse control by simultaneously deactivating valve H to redirect hydraulic fluid from the first transport line (Lower EHR) to the return line R (while valves A, B, C, D, and E are deactivated and valves I, F, and G are activated) during the first operation 100. Then, with additional reference to FIG. 6, where like numerals refer to like parts throughout, in a second operation 110 the controller 60 can further execute to enable such filtering by simultaneously deactivating valve I to redirect hydraulic fluid from the second transport line (Raise EHR) to the return line R (while valves A, B, C, D, and E are deactivated, and valves G, F, and H are activated) during the second operation 110. Then, with additional reference to FIG. 7, where like numerals refer to like parts throughout, in a third operation 120 the controller 60 can further execute to enable complete coarse and fine control fluid filtering by simultaneously deactivating valve C (while valves A, B, D, and E are deactivated) to redirect fluid from the supply line P to the return line R through the connector 102 (fine control fluid filtering), and deactivating valves H and I (while valves F and G are activated) to redirect fluid from the first transport line to the second transport line through the connector 112 (coarse control fluid filtering).

As a result, contaminants in the fluid can be efficiently filtered by the filtration system 65 by conducting one or more of the aforementioned operations blocking fluid from going through cylinders 40 and valves A, B, D, E, F and/or G for precisely controlling such cylinders 40 by using one or more of dedicated return valves C, H and/or I to return the fluid to the hydraulic power source 61 through connectors 102 and/or 112. Moreover, such aforementioned operations can be advantageously executed immediately following connection of the hydraulic power source 61 to the manifold 82.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. An off-highway implement, comprising:
a frame supported by a plurality of wheels;
a set of ground engaging tools supported by the frame, the set of ground engaging tools including a hydraulic cylinder arranged with respect to the frame for raising and lowering the set of ground engaging tools, the hydraulic cylinder comprising a base, a base port, a rod and a rod port, wherein the rod is configured to extend from the base when hydraulic fluid is supplied to the base port and returned from the rod port, and wherein the rod is configured to retract toward the base when hydraulic fluid is supplied to the rod port and returned from the base port;
a connector configured to supply hydraulic fluid in a supply line and return hydraulic fluid in a return line when connected to a hydraulic power source;
a plurality of electronically controlled valves, the plurality of valves including a first valve configured to supply hydraulic fluid from the supply line to the hydraulic cylinder when activated, a second valve configured to return hydraulic fluid from the hydraulic cylinder to the return line when activated, and a third valve configured to bypass the first and second valves by redirecting the hydraulic fluid from the supply line to the return line when deactivated; and
a controller in communication with the plurality of valves, the controller executing a program stored in a non-transient medium to:
execute an operation to enable filtering of the hydraulic fluid supplied through the connector by simultaneously deactivating the first and second valves to block hydraulic fluid with respect to the hydraulic cylinder while deactivating the third valve to redirect hydraulic fluid from the supply line to the return line.

2. The system of claim 1, wherein the first and second valves are single direction, proportional control valves configured to meter hydraulic fluid for fine adjustment of the hydraulic cylinder.

3. The system of claim 2, further comprising fourth and fifth electronically controlled valves, wherein the fourth and fifth valves are bi-directional, on-off valves without proportional control for coarse adjustment of the hydraulic cylinder, or isolation of the fine adjustment valves, wherein the fourth valve is configured to supply and return hydraulic fluid with respect to the rod port of the hydraulic cylinder, and wherein the fifth valve is configured to supply and return hydraulic fluid with respect to the base port of the hydraulic cylinder.

4. The system of claim 3, wherein the connector is a first connector, and further comprising a second connector configured to transport hydraulic fluid in first and second transport lines when connected to a hydraulic power source, wherein the fourth valve is connected to the first transport line and the fifth valve is connected to the second transport line.

5. The system of claim 4, further comprising a sixth electronically controlled valve configured to bypass the fourth valve by redirecting hydraulic fluid from the second connector to the return line when deactivated.

6. The system of claim 5, further comprising a seventh electronically controlled valve configured to bypass the fifth valve by redirecting hydraulic fluid from the second connector to the return line when deactivated.

7. The system of claim 6, wherein the operation is a first operation and further comprising the controller executing a first operation to enable filtering of the hydraulic fluid supplied through the second connector by simultaneously activating the fourth, fifth, and seventh valves while deactivating the sixth valve to return hydraulic fluid in the second connector to the return line.

8. The system of claim 7, wherein the operation is a second operation, and further comprising the controller executing a third operation to enable filtering of the hydraulic fluid supplied through the second connector by simultaneously activating the fourth and fifth valves while deactivating the sixth and seventh valves to return hydraulic fluid in the second connector to the return line.

9. The system of claim 8, wherein the operation is a first operation, and further comprising the controller executing a second operation to enable filtering of the hydraulic fluid supplied through the second connector by simultaneously activating the fourth, fifth, and sixth valves while deactivating the seventh valve to return hydraulic fluid in the second connector to the return line.

10. The system of claim 1, wherein the first and second valves are configured to supply and return hydraulic fluid, respectively, with respect to the rod port of the hydraulic cylinder when activated.

11. The system of claim 9, wherein the hydraulic cylinder is a first hydraulic cylinder, wherein the set of ground engaging tools further includes a second hydraulic cylinder arranged with respect to the frame for raising and lowering the set of ground engaging tools, wherein the first and second valves are configured to supply and return hydraulic fluid, respectively, with respect to the rod ports of the first and second hydraulic cylinders.

12. The system of claim 1, further comprising a hydraulic power source attached to the connector, the hydraulic power source comprising a hydraulic fluid reservoir, a pump and a filter, wherein the operation enables cleaning of the hydraulic fluid by driving the hydraulic fluid through the filter.

13. The system of claim 1, wherein the connector enables connection and disconnection of a plurality of hydraulic hoses in a manifold.

14. The system of claim 1, wherein the execution of the filtration operation is commanded either manually by an operator or automatically without an operator.

15. The system of claim 6, wherein the third, sixth, and seventh valves are activated (instead of deactivated) to connect their respective transport lines to the return line.
